(19) United States
(12) Patent Application Publication
(10) Pub. No.: US 2016/0188744 A1
(43) Pub. Date: Jun. 30, 2016

(54) DATA DETECTION METHOD, DATA DETECTION DEVICE, AND PROGRAM

(71) Applicant: HITACHI, LTD., Tokyo (JP)

(72) Inventors: Hideaki ITO, Tokyo (JP); Hirofumi DANNO, Tokyo (JP); Atsushi SASHINO, Tokyo (JP); Takuya HARAGUCHI, Tokyo (JP)

(73) Assignee: HITACHI, LTD., Tokyo (JP)

(21) Appl. No.: 14/891,842

(22) PCT Filed: May 17, 2013
(86) PCT No.: PCT/JP2013/036739

§ 371 Date: Feb. 16, 2016

(51) Int. Cl. G06F 17/30

(52) U.S. Cl. CPC G06F 17/30896; G06F 17/30011; G06F 17/30563

(57) ABSTRACT

The present invention enables designated data to be extracted from a structured document even when the structured document differs from others in terms of screen layout and document structure. A first structured document is read in and outputted to an output device; a first label to be extracted and first data to be extracted are acquired via an input device; an extraction pattern representing a relative relation in document structure between the first label to be extracted and the first data to be extracted is generated; and the extraction pattern is stored in a storage device. A second structured document is read in; a second label to be extracted is acquired; an extraction rule for extracting, from the second structured document and on the basis of the extraction pattern stored in the storage device and the second label to be extracted, second data to be extracted corresponding to the second label to be extracted is generated; and the second data to be extracted is extracted from the second structured document on the basis of the extraction rule.

### TECHNICAL FIELD

The present invention relates to technology for extracting information of a structured document described in HTML or the like.

### BACKGROUND ART

There has been a demand to extract designated information in a structured document described in HTML or the like. For example, if, in a business system, a case ID in an HTML document displayed on a browser in a client PC can be extracted, a work ID (such as a string in a title tag in the HTML document) and a received time of the HTML document which are associated with the case ID may be used to arrange the work IDs of the same case ID in time series, visualizing a work process. Here, there is a demand to accurately extract the case ID from various HTML documents to which the business system may respond.

Related arts for achieving the above are described below. As one of them, there has been a method in which an extraction rule (such as XPath) for extracting a common portion between analogous Web pages is generated and stored to be associated with an identification rule (such as URL) for identifying the Web page, if a Web page to be extracted is input, the extraction rule is selected on the basis of the identification rule of the Web page, extraction is made on the basis of the extraction rule from the Web page to be extracted (see Patent literature 1, for example). As another one of them, there has been a method in which an array is accumulated as positional information, the array having as components coordinates of a node corresponding to a portion which is specified by a user from a displayed Web page and coordinates of a series of nodes at levels upper than the former node, and if a Web page to be extracted is input, extraction is made on the basis of the accumulated positional information (see Patent literature 2, for example).

### CITATION LIST

### Patent Literature

PATENT LITERATURE 1: JP-A-2012-59212

PATENT LITERATURE 2: Japanese Patent No. 4046000

### SUMMARY OF INVENTION

### Technical Problem

However, the former method has a problem in that because of the analogous Web pages, a plurality of common portions generally exist, but no description is given of a method of designation among them, and thus, the designated information cannot be extracted. In addition, the latter method has a problem in that since the positional information represents the node specified by the user in an absolute positional relationship with reference to a route node as a base point, it is weak in change in the Web page in terms of screen layout and document structure. For example, the Web page change in terms of document structure includes addition/deletion of a table (table tag in HTML), addition/deletion of a table row (<tr> tag in HTML), and the like.

The present invention has been made in consideration of the above points and has an object to provide a data extraction method capable of extracting designated data from a structured document such as a Web page even when the structured document differs from others in terms of screen layout and document structure, a data extraction device and a program which implement the method.

### Solution to Problem

A representative example of the present invention is as below. In other words, the present invention provides a data extraction method in a data extraction device extracting data from a structured document, including reading in a first structured document to output to an output device, acquiring a first label to be extracted and first data to be extracted via an input device, generating an extraction pattern representing a relative relationship in terms of document structure between the first label to be extracted and the first data to be extracted, storing the extraction pattern in a memory device, reading in a second structured document, acquiring a second label to be extracted, generating, on the basis of the extraction pattern stored in the memory device and the second label to be extracted, an extraction rule for extracting from the second structured document second data to be extracted corresponding to the second label to be extracted, and extracting on the basis of the extraction rule the second data to be extracted from the second structured document.

### Advantageous Effects of Invention

According to the present invention, since the data to be extracted corresponding to the label to be extracted can be identified from the structured document of interest by generating the extraction pattern, even when the structured document such as a Web page differs from others in terms of screen layout and document structure, designated data can be extracted from the structured document.

### BRIEF DESCRIPTION OF DRAWINGS

FIG. 1 is a diagram illustrating a hardware configuration example of a data extraction device 1 according to an embodiment of the invention.

FIG. 2 is a diagram illustrating a functional block of the data extraction device 1 according to an embodiment of the invention.

FIG. 3 is a diagram illustrating a structured document example and a screen example for instructing to generate an extraction pattern after reading in the structured document according to an embodiment of the invention.

FIG. 4 is a flowchart illustrating a process for generating the extraction pattern according to an embodiment of the invention.

FIG. 5 is a diagram illustrating a data formation example in an extraction pattern storage unit 106 according to an embodiment of the invention.

FIG. 6 is a diagram illustrating an example of a list 107 of labels to be extracted according to an embodiment of the invention.

FIG. 7 is a flowchart illustrating a process for generating an extraction rule according to an embodiment of the invention.

FIG. 8 is a diagram illustrating an output screen example in extracting data from the structured document of interest according to an embodiment of the invention.

### DESCRIPTION OF EMBODIMENTS

Hereinafter, a description is given of an embodiment according to the present invention with reference to the drawings.

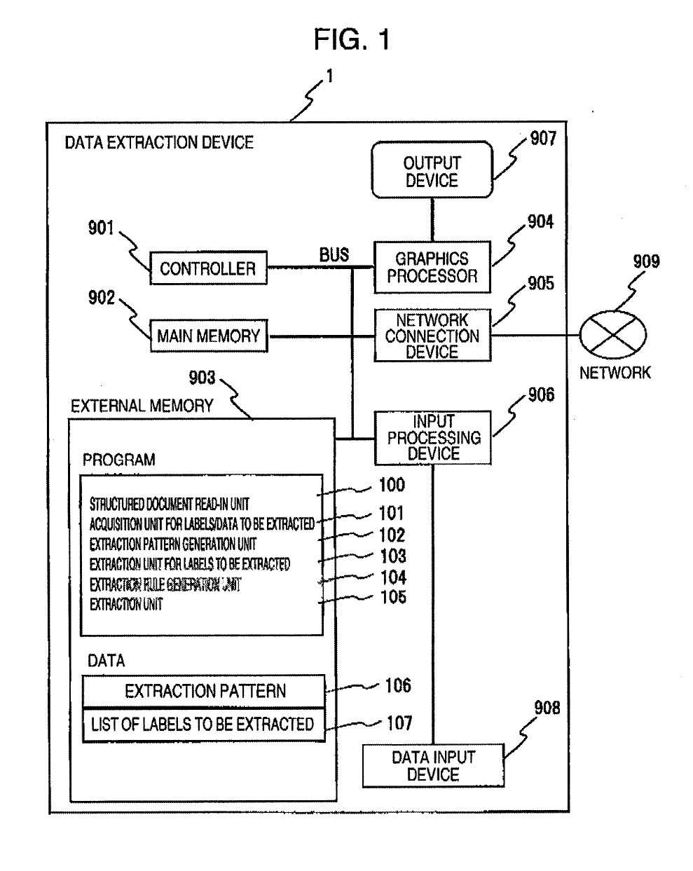

FIG. 1 is a diagram illustrating a hardware configuration example of a data extraction device 1 according to an embodiment of the invention. As shown in FIG. 1, the data extraction device 1 is achieved by a general electronic computer (computer) and includes a controller 901 such as a CPU, a main memory 902, an external memory 903, a graphics processor 904, a network connection device 905 connected with a network 909, an input processing device 906, an output device 907 such as a display, and a data input device 908. The respective devices are connected with each other via a BUS (bus). The external memory 903 has a program stored therein which is constituted by a structured document read-in unit 100 for reading in a structured document including an HTML document, an acquisition unit 101 for labels/data to be extracted, an extraction pattern generation unit 102, an extraction unit 103 for labels to be extracted, an extraction rule generation unit 104, a data extraction unit 105 for extracting designated information from a structured document of interest. These programs are stored in the external memory (903), and they can be read in by the main memory 902, processed by the controller 901 and the like to be executed. The program for achieving the respective units may be stored in the external memory 903 in advance, may be stored in a storage medium having portability usable to the electronic computer such that the program is read out as needed via a reading device not shown, or may be those downloaded as needed, to be stored in the external memory 903, from the network 909 that is a communication medium usable to the electronic computer or from another device connected with the network connection device 905 which uses a carrier propagating on the network 909. Moreover, the external memory 903 has stored therein an extraction pattern generated by the extraction pattern generation unit 102 and a list 107 of labels to be extracted in which a label to be extracted is described in advance. Hereinafter, a unit for storing the extraction pattern in the external memory 903 is defined as an extraction pattern storage unit 106. Further, hereinafter, a description is given using a slip number as an example of the label to be extracted that is information for identifying a case.

A description is given of an operation of the data extraction device 1 having such a configuration. First, a structured document (sample) for extraction pattern generation input via the data input device 908 and the input processing device 906 or a structured document for extraction pattern generation stored in the external memory 903 in advance is read in by the structured document read-in unit 100 and output via the graphics processor 904 to the output device 907. Next, the acquisition unit 101 for labels/data to be extracted acquires a label to be extracted and data to be extracted which are each a string designated on an output screen, the extraction pattern generation unit 102 generates the extraction pattern representing a relative relationship in terms of document structure between the label to be extracted and the data to be extracted, and the generated extraction pattern (data) is stored in the external memory 903. Next, the structured document read-in unit 100 reads in a structured document of interest for data extraction input via the data input device 908 and the input processing device 906 or a structured document of interest for data extraction stored in the external memory 903 in advance, and the extraction unit 103 for labels to be extracted extracts the label to be extracted from the list 107 of labels to be extracted. The extraction rule generation unit 104 generates an extraction rule for extracting from the structured document of interest the data to be extracted corresponding to the label to be extracted on the basis of the extraction pattern 106 and the label to be extracted. The extraction unit 105 extracts from the structured document of interest the data to be extracted corresponding to the label to be extracted on the basis of the extraction rule.

In this way, the data extraction device 1 according to the embodiment can extract from the structured document of interest the data to be extracted corresponding to the label to be extracted by generating an extraction pattern 10.

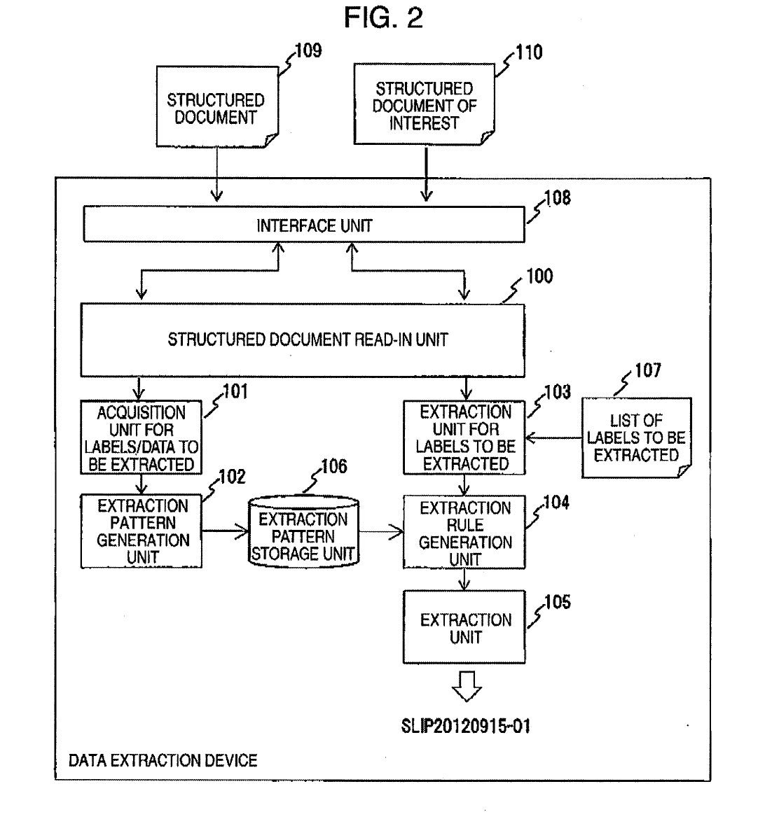

Hereinafter, a description is given in detail of information processing performed by the data extraction device 1 with reference to FIG. 2 to FIG. 8.

FIG. 2 is a diagram illustrating a functional block of the data extraction device 1 according to an embodiment of the invention. The data extraction device 1 is constituted by the respective functional blocks including the structured document read-in unit 100, the acquisition unit 101 for labels/data to be extracted, the extraction pattern generation unit 102, the extraction unit 103 for labels to be extracted, the extraction rule generation unit 104, the extraction unit 105, the extraction pattern storage unit 106, and the interface unit 108.

Hereinafter, operation of each function in the above configuration is described in detail. The structured document read-in unit 100 reads in a structured document for extraction pattern generation 109 and a structured document of interest for data extraction 110 via the interface unit 108.

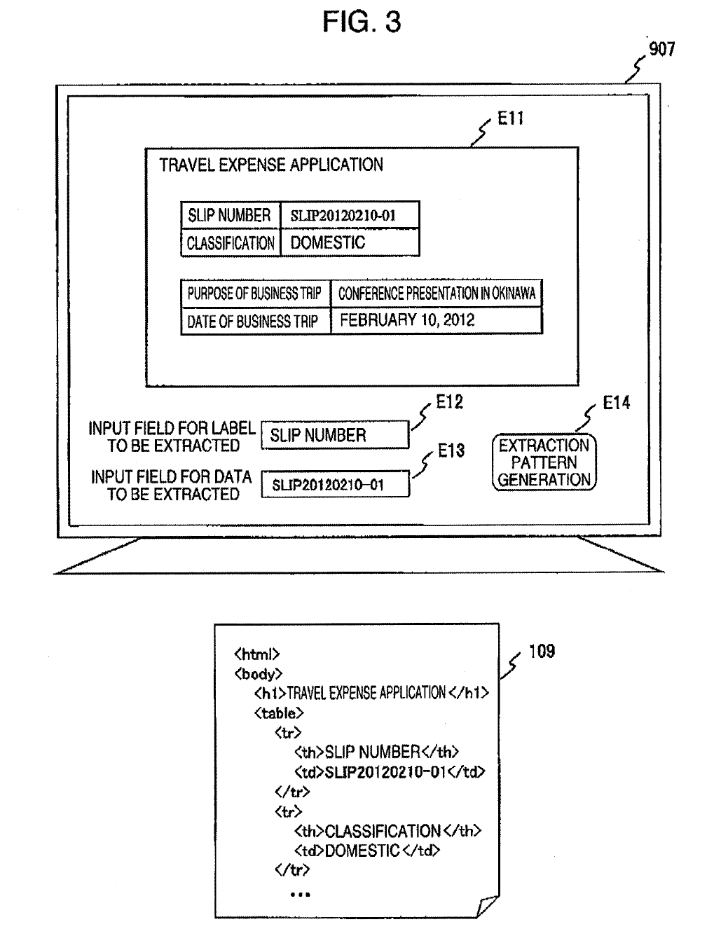

FIG. 3 is a diagram illustrating an example of the structured document 109 and a screen example for instructing to generate an extraction pattern after reading in the structured document according to an embodiment of the invention. Note that the structured document of interest for data extraction 110 also has content similar to the structured document 109. An extraction pattern generation instructing screen is constituted by a screen in-line frame element E11 for displaying the structured document 109 read in by the structured document read-in unit 100, an input field E12 to which a string of the label to be extracted for extraction pattern generation is input, an input field E13 to which a string of the data to be extracted for extraction pattern generation is input, an extraction pattern generation instructing button E14 for instructing to generate the extraction pattern, and the like. When an operation is performed such as by pressing down the extraction pattern generation instructing button E14 by a user, the acquisition unit 101 for labels/data to be extracted acquires the strings of the label to be extracted and the data to be extracted which are input to the input field E12 and the input field E13, and the acquired label to be extracted and data to be extracted are passed to the extraction pattern generation unit 102. Note that in FIG. 3 the structured document 109 read in by the structured document read-in unit 100 is displayed in the screen in-line frame element E11.

The extraction pattern generation unit 102 acquires the label to be extracted and the data to be extracted from the acquisition unit 101 for labels/data to be extracted, generates the extraction pattern representing the relative relationship in terms of document structure between the acquired label to be extracted and data to be extracted, and stores the generated extraction pattern in the extraction pattern storage unit 106.

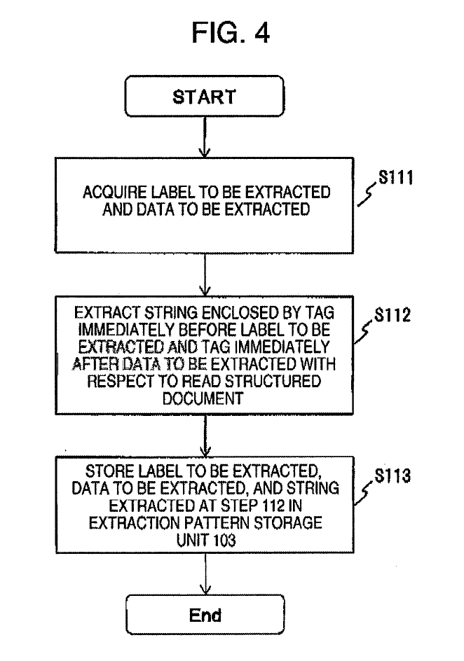

FIG. 4 is a flowchart illustrating a process for generating the extraction pattern according to an embodiment of the invention. When the extraction pattern generation unit 102 acquires the label to be extracted and the data to be extracted from the acquisition unit 101 for labels/data to be extracted (step S111), it extracts, from the structured document for extracting the extraction pattern read in by the structured document read-in unit 100, a string enclosed by a tag immediately before the label to be extracted and a tag immediately after the data to be extracted (step S112), and stores the label to be extracted, the data to be extracted, and the string extracted at step S112 as the extraction pattern in the extraction pattern storage unit (step S113).

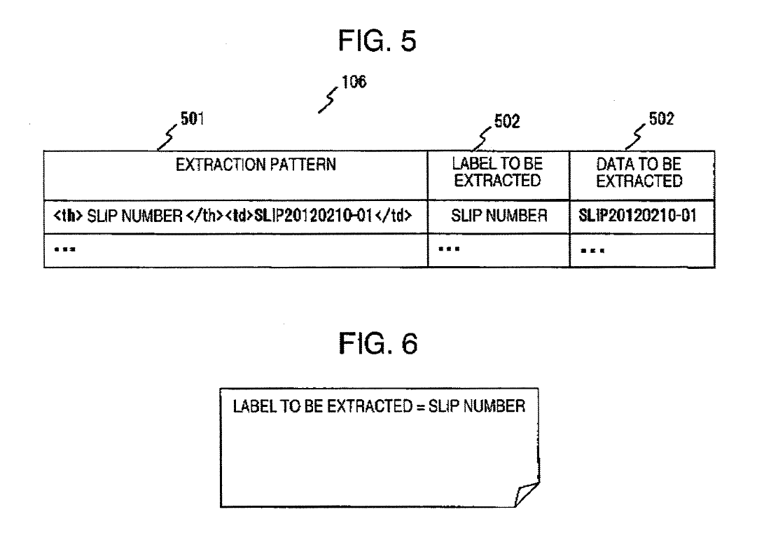

FIG. 5 is a diagram illustrating a data formation example in the extraction pattern storage unit 106 according to an embodiment of the invention. The extraction pattern storage unit 106 has stored therein an extraction pattern 501 generated by the extraction pattern generation unit 102, a label 502 to be extracted used in generating the extraction pattern, data 503 to be extracted used in generating the extraction pattern which are associated with each other. Here, an example is shown in which the extraction pattern is stored in a case where the label to be extracted is “slip number” and the data to be extracted is “SLIP20120210-01” for the structured document 109 (FIG. 3). Note that in order to improve reusability of the extraction pattern, linefeed marks, tab marks, space marks or attribute information on tags may be adequately deleted from the string extracted at step S112.

Returning to FIG. 2, the description is continued. The extraction unit 103 for labels to be extracted reads in the list 107 of labels to be extracted and extracts the label to be extracted from the list 107 of labels to be extracted. The list 107 of labels to be extracted has stored therein a label to be extracted of the data intended to be extracted.

FIG. 6 is a diagram illustrating an example of the list 107 of labels to be extracted. The list 107 of labels to be extracted has the label to be extracted described therein. Here, a case is shown where the “slip number” is described as the label to be extracted.

The extraction rule generation unit 104 acquires the label to be extracted from the extraction unit 103 for labels to be extracted, and generates the extraction rule for extracting from the structured document 110 read in by the structured document read-in unit 100 the data to be extracted corresponding to the label to be extracted.

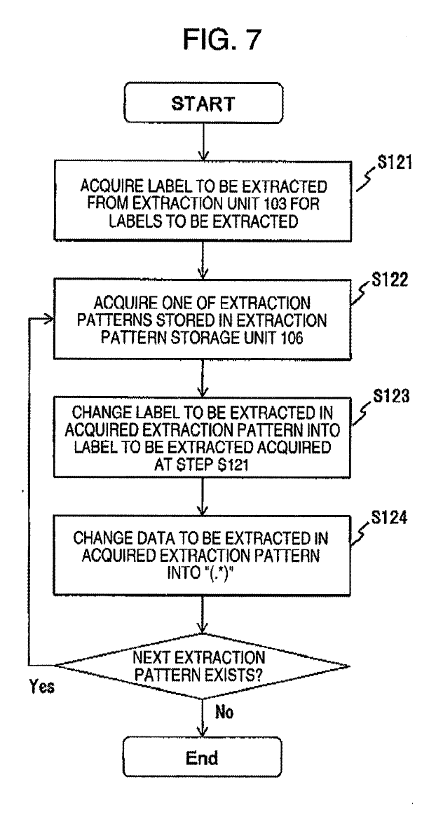

FIG. 7 is a flowchart illustrating a process for generating an extraction rule according to an embodiment of the invention. When the extraction rule generation unit 104 acquires the label to be extracted from the extraction unit 103 for labels to be extracted (step S121), it acquires one of the extraction patterns stored in the extraction pattern storage unit 106 (step S122), and changes the label to be extracted in the acquired extraction pattern into the label to be extracted acquired at step S121 (step S123). Moreover, the extraction rule generation unit 104 changes the data to be extracted in the extraction pattern acquired at step S122 into “(.*)” (step S124). The extraction rule generation unit 104 repeats the process from step S122 to step S124 for every extraction pattern stored in the extraction pattern storage unit 106. For example, for the extraction pattern “<th>slip number </th><td>SLIP20120210-01</td>” shown in FIG. 5 stored in the extraction pattern storage unit 106, if the label to be extracted received at step S121 is “slip NO”, the extraction rule to be generated is “<th>slip NO</th><td>(.*)</td>”. Note that the extraction rule generated by the extraction rule generation unit 104 of the embodiment is described in a regular expression, and the string in parentheses after match can be extracted in the regular expression by the extraction unit 106. However, the description of the extraction rule is not limited to the regular expression, and may be a series of procedures or a program. For example, the extraction rule may be described in a path (such as XPath) to a node of the data to be extracted or may be a program using a DOM (Document Object Model) API published by the W3C.

Returning to FIG. 2, the description is continued. The extraction unit 105 acquires the extraction rule from the extraction rule generation unit 104, and extracts based on the extraction rule the data from the structured document of interest 110 by use of known technology such as a regular expression engine represented, for example, by the Perl.

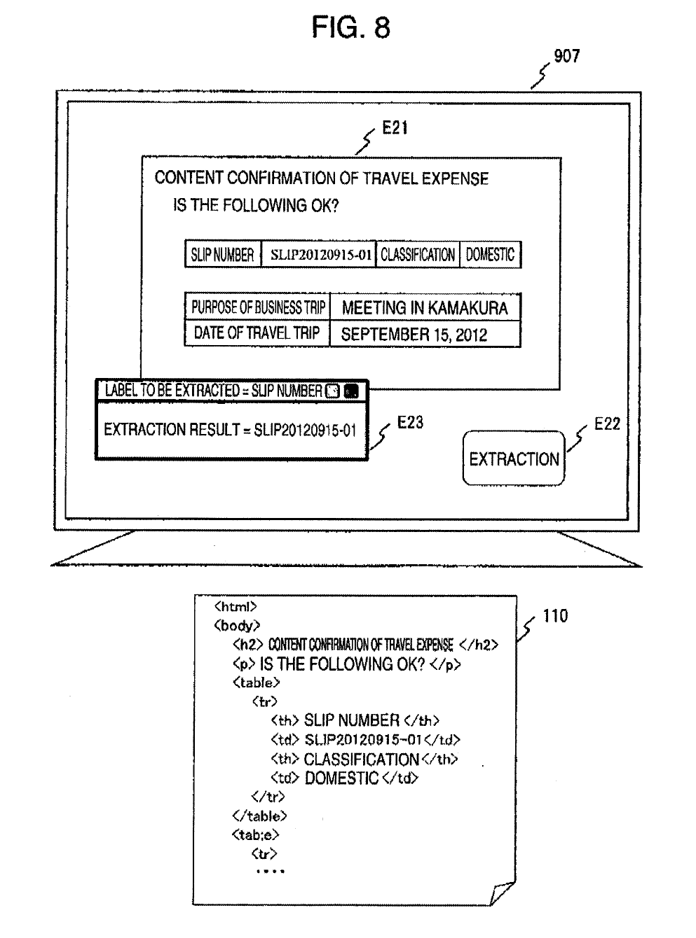

FIG. 8 is a diagram illustrating an output screen example in extracting data from the structured document of interest according to an embodiment of the invention. The output screen is constituted by a screen in-line frame element E21 for displaying the structured document of interest 110 read in by the structured document read-in unit 100, an extraction button E22 for instructing to extract the information, and the like. When an operation is performed such as by pressing down the extraction button E22 by a user, the extraction unit 103 for labels to be extracted is brought into action and a result of the action is output to a screen dialogue element E23 or the like.

According to the embodiment described above, since the data to be extracted corresponding to the label to be extracted can be identified from the structured document of interest by generating the extraction pattern, even when the structured document such as a Web page differs from others in terms of screen layout and document structure, designated data can be extracted from the structured document. Moreover, a work ID and a received time of the structured document which are associated with the identified data to be extracted may be used to arrange the work IDs of the same case in time series, visualizing a work process.

Note that the embodiment of the invention is not limited to the above embodiment and various modifications may be made. For example, the above embodiment is described using the slip number as an example of the label to be extracted, but other information may be used so long as it is information capable of identifying the case. In addition, expansion of the extraction pattern described above may make it possible to deal with extraction of the designated data from various business system screens. For example, in a case where the extraction rule is manually set for each business system screen by a knowledgeable person or the like, the extraction rule may not need to be created from the beginning, but the appropriate extraction pattern may be selected, which allows a setting work therefor to be efficiently carried out. Further, each program for the structured document read-in unit 100, the acquisition unit 101 for labels/data to be extracted, the extraction pattern generation unit 102, the extraction unit 103 for labels to be extracted, the extraction rule generation unit 104, and the extraction unit 105 in the above embodiment may be achieved by hardware such as an LSI.

### REFERENCE SIGNS LIST

901 controller
902 main memory
903 external memory
904 graphics processor
905 network connection device
906 input processing device
907 output device
908 data input device
909 network

1. A data extraction method in a data extraction device extracting data from a structured document, comprising:
reading in a first structured document to output to an output device;
acquiring a first label to be extracted and first data to be extracted via an input device;
generating an extraction pattern representing a relative relationship in terms of document structure between the first label to be extracted and the first data to be extracted;
storing the extraction pattern in a memory device;
reading in a second structured document;
acquiring a second label to be extracted;
generating, on the basis of the extraction pattern stored in the memory device and the second label to be extracted, an extraction rule for extracting from the second structured document second data to be extracted corresponding to the second label to be extracted; and
extracting on the basis of the extraction rule the second data to be extracted from the second structured document.

2. The data extraction method according to claim 1, wherein
a string is extracted from the first structured document, the string being enclosed by a tag immediately before the first label to be extracted and a tag immediately after the first data to be extracted, and
the extracted string is stored as the extraction pattern in the memory device.

3. The data extraction method according to claim 2, wherein
acquiring the extraction pattern from the memory device when the second label to be extracted is acquired,
changing the first label to be extracted in the acquired extraction pattern into the second label to be extracted and further changing the first data to be extracted in the acquired extraction pattern into (.*) to generate the extraction rule.

4. A data extraction device extracting data from a structured document, comprising:
a controller; a memory device; an input device; and an output device, wherein
the controller
reads in a first structured document to output to the output device,
acquires a first label to be extracted and first data to be extracted via the input device,
generates an extraction pattern representing a relative relationship in terms of document structure between the first label to be extracted and the first data to be extracted,
stores the extraction pattern in the memory device,
reads in a second structured document,
acquires a second label to be extracted,
generates, on the basis of the extraction pattern stored in the memory device and the second label to be extracted, an extraction rule for extracting from the second structured document second data to be extracted corresponding to the second label to be extracted, and
extracts on the basis of the extraction rule the second data to be extracted from the second structured document.

5. The data extraction device according to claim 4, wherein
the controller
extracts a string from the first structured document, the string being enclosed by a tag immediately before the first label to be extracted and a tag immediately after the first data to be extracted, and
stores the extracted string as the extraction pattern in the memory device.

6. The data extraction device according to claim 5, wherein
the controller
acquires the extraction pattern from the memory device when acquiring the second label to be extracted, and
changes the first label to be extracted in the acquired extraction pattern into the second label to be extracted and further changes the first data to be extracted in the acquired extraction pattern into (.*) to generate the extraction rule.

7. A computer-readable program for controlling a computer of a data extraction device extracting data from a structured document, the program causing the computer to function as:
means for reading in a first structured document to output to an output device;
means for acquiring a first label to be extracted and first data to be extracted via an input device;
means for generating an extraction pattern representing a relative relationship in terms of document structure between the first label to be extracted and the first data to be extracted;
means for storing the extraction pattern in a memory device;
means for reading in a second structured document;
means for acquiring a second label to be extracted;
means for generating, on the basis of the extraction pattern stored in the memory device and the second label to be extracted, an extraction rule for extracting from the second structured document second data to be extracted corresponding to the second label to be extracted; and
means for extracting on the basis of the extraction rule the second data to be extracted from the second structured document.

8. The computer-readable program according to claim 7, further causing the computer to function as:
means for extracting a string from the first structured document, the string being enclosed by a tag immediately before the first label to be extracted and a tag immediately after the first data to be extracted; and
means for storing the extracted string as the extraction pattern in the memory device.

9. The computer-readable program according to claim 8, causing the computer to function as:
means for acquiring the extraction pattern from the memory device when the second label to be extracted is acquired; and
means for changing the first label to be extracted in the acquired extraction pattern into the second label to be extracted and further changing the first data to be extracted in the acquired extraction pattern into (.*) to generate the extraction rule.
